(19) United States
(12) Patent Application Publication
(10) Pub. No.: US 2007/0103907 A1
(43) Pub. Date: May 10, 2007

(54) Retractable light assembly for a barbeque

(76) Inventors: David J. Popowich, Brampton (CA); Simon Treadwell, Toronto (CA); Christopher J. Reis, Brampton (CA)

Correspondence Address: MICHAEL H. BANIAK;BANIAK PINE & GANNON, Suite 1200, 150 North Wacker Drive, Chicago, IL, 60606, US

(21) Appl. No.: 11/270,772

(22) Filed: Nov. 9, 2005

(51) Int. Cl. F21S 8/00

(52) U.S. Cl. 362/277

(57) ABSTRACT

A retractable light assembly for a barbeque. The light assembly includes casing components that cooperate so that a light source is extendable from and retractable from an operation area of the barbeque. The light assembly includes an outer casing. The outer casing is hollow and includes a mount. The mount is attachable to the barbeque. An inner casing is sized and shaped to be extendably disposed in the outer casing and a light source is connected to the inner casing and operably attached to a power source. The light source is positioned in the inner casing so as to illuminate a work surface of the barbeque when the inner casing is in an extended condition from the outer casing.

### FIELD OF THE INVENTION

The present invention relates to a system and method for providing illumination. More particularly, the present invention is directed to lighting systems and methods for providing illumination to an operation area, such as the food preparation or cooking areas of a barbeque or grill. In another embodiment, the subject invention relates to an operating assembly such as a barbeque or grill that includes a retractable light assembly for illuminating one or more operation areas thereof.

### BACKGROUND OF THE INVENTION

The barbeque continues to increase in popularity. Presently, about 80% of families in the United States own and use a barbeque, also known as a grill. Even though it was once largely only a summertime activity, barbecuing is now done throughout the year, in all weather, and even after sunset. Many accessories are available for the grill including a variety of lighting systems to enhance use of the grill. However, it has been found that there are disadvantages to known grill lighting systems. For example, one such lighting system has been proposed for use with an otherwise conventional grill having a hinged lid for covering a grilling surface of the barbeque. The hinged lid includes a handle on a front panel or side by which the lid may be lifted. The lighting system is positioned in the barbeque handle. However, the lighting system integrated into the lid handle is subjected to the heat emanating from the grill area covered by the lid. When the lid is lifted, the heat, smoke, moisture, and other possible by-products created by the cooking process come into contact with the lid handle lighting system. This is particularly true of those lid handle lights that are or can be positioned in or above the grilling surface after the lid is lifted. This can make the lighting system hot to the touch. Also, the heat and moisture can damage the components of the light, such as the circuitry, while smoke and grease, and the like, can cloud the lens of the light. Overall, heat can shorten the life of known lighting systems and any electrical components exposed to the heat in the lid and handle.

Other lighting systems attach or are intended to be positioned on or around the barbeque. These known systems take up valuable space of the barbeque work surface and are vulnerable to physical damage during use of the barbeque. For example, one such lighting system includes a gooseneck-mounted lamp that is attachable to the barbeque by a clamp. Since it must be clamped to the barbeque, the lamp cannot easily or quickly be removed from the barbeque, particularly by the person attempting to cook on the barbeque. The gooseneck mounted lamp also may be bent to any position, including a dangerous position within the travel of the barbeque lid, thereby making it vulnerable to breakage during opening and closing of the lid. Such failures would leave the consumer at risk of glass falling into the food being prepared. As with the lid handle light, the gooseneck lamp when positioned over the grill is exposed to damaging heat and moisture and impaired by cooking by-products.

Accordingly, there is a demand therefore for a simple, safe, and effective assembly that provides light to an operation area, work surface, or grilling surface of a barbeque grill or any other application where illumination is needed without taking valuable working space adjacent to these areas or surfaces. The present invention satisfies the demand.

### SUMMARY OF THE INVENTION

The present invention has a principal objective of providing illumination to an otherwise conventional barbeque having at least an operating area. One example of an operation area is a grilling surface. One embodiment of the present invention provides a light assembly that includes an outer casing and an inner casing that are sized and shaped and cooperate so that the assembly is retractable. An embodiment of the light system includes an apparatus by which the casing, and therefore the light assembly may be attachable to the barbeque. The outer casing includes an inner wall that defines a receiving aperture and an outer wall by which the light assembly may be attached to the barbeque. The light assembly may include an inner casing sized and shaped to be received in the receiving aperture and from which the inner casing may be extended. A light source is positioned in the inner casing by which an operation area of the barbeque may be illuminated when the inner casing is in an extended condition from the outer casing.

Other embodiments of the present invention provide an outer causing including a first outer housing component connected to a second outer housing component. The outer casing may include a pair of longitudinal channels formed therethrough. The inner casing may have a pair of pins extending therefrom. Each of the pair of pins sized, shaped and positioned so as to slidingly engage with one of the pair of longitudinal channels. In another embodiment, the unit could be rotated up into position.

The mount or mounting apparatus may include a flange extending from the outer casing by which the retractable light assembly may be mounted flush with a horizontal surface of the barbeque when the retractable light assembly is in a retracted condition. The mounting flange may include a pair of access holes sized and shaped to permit a user to grasp the inner casing. The retractable light assembly may further include a lens cap positioned atop the inner casing and covering the light source. The inner casing may include an inclined shoulder that may be annular and a lens cap that may have an inclined bottom edge to match the inclined shoulder.

The source of the light for the retractable light assembly can include an array of LEDs. The inner casing may include a pawl and the outer casing may include a notch, the notch being positioned in the outer casing such that the pawl and notch engage when the inner casing is extended from the outer casing. In another embodiment, the cap could be a “push to release,” or “twist lock” design.

These and other advantages, as well as the invention itself, will become apparent in the details of construction and operation as more fully described and claimed below. Moreover, it should be appreciated that several aspects of the invention can be used in other applications where illumination of a work surface or operation area would be desirable.

### BRIEF DESCRIPTION OF THE DRAWINGS

FIG. 1 illustrates a perspective view according to one embodiment of the present invention showing a retractable light assembly in an extended mode;

FIG. 2 illustrates a perspective view of the assembly of FIG. 1 in a retracted mode;

FIG. 3 illustrates a partially exploded, partial view of a lower portion of an inner housing of the present invention;

FIG. 4 illustrates a partially exploded view of the light assembly of FIG. 1;

FIG. 5 illustrates a partially exploded, partial view of an upper portion of an inner housing of the present invention;

FIG. 6 illustrates a perspective view of a retractable light assembly mounted within and in a retracted mode in a barbeque;

FIG. 7 illustrates a perspective view of a retractable light assembly mounted within and in an extended mode from a barbeque; and

FIG. 8 illustrates a perspective view of a barbeque with an embodiment of the retractable light assembly extended from the barbeque.

### DETAILED DESCRIPTION OF A PRESENTLY PREFERRED EMBODIMENT

An assembly for illuminating a barbeque according to the present invention is identified in the accompanying drawings as 10. The assembly 10 includes two main components, namely, an outer casing 12—having an inner wall 13 sized and shaped to define a receiving aperture 13A—and an inner casing 14, having an outer wall 15, which is sized and shaped to fit within the receiving aperture 13A of the outer casing. An aspect of the present invention is that the inner casing 14 is extendable and/or telescopes from the outer casing 12.

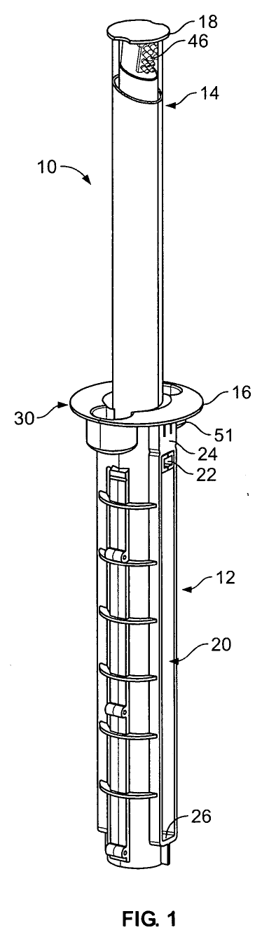

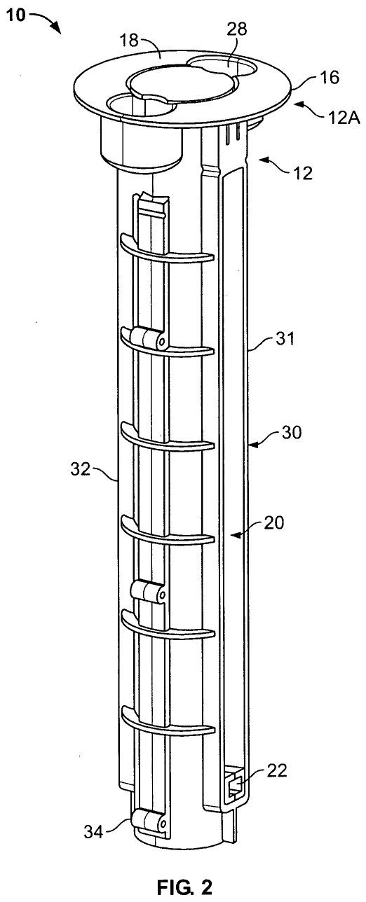

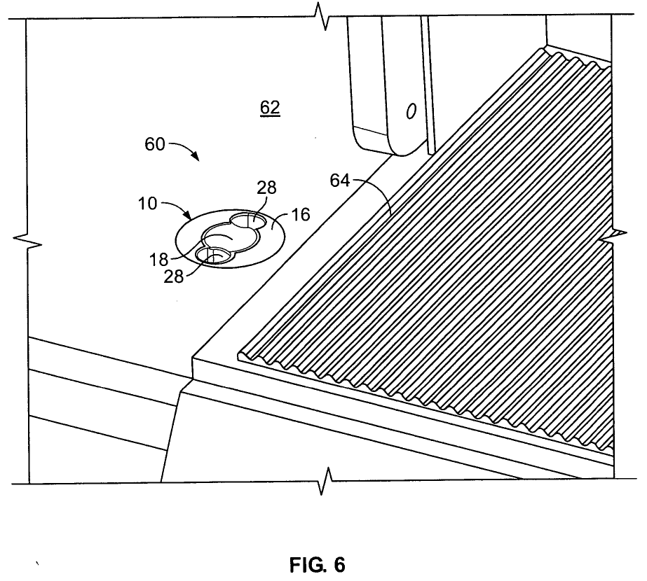

One embodiment of the assembly 10 is shown in FIGS. 1 and 2 and includes an outer casing 12 formable from two major casing components 30—a first outer housing component 31 and a second outer housing component 32. The first outer housing component 31 and the second outer housing component 32 are sized and shaped so that they may be fastened together to form an essentially hollow container, and thereby the outer casing 12. Housing components 31, 32, of the FIG. 2 embodiment, each may include a channel 20 formed therein, oriented generally longitudinally along the outer casing 12. Channels 20 may be opposite each other when the housing components 31, 32 are joined to form outer casing 12. The channel 20 may include a top end 24 that may function as an upper stop and a bottom end 26 that may function as a lower stop (explained in more detail below). A flange 16 may extend radially from an upper end 12A of the outer casing 12 of which the outer casing may be mounted to the grill surface 62 (see FIG. 6). The outer casing 12, and therefore the assembly 10 may be attached by a variety of other means to a flat surface, like a work surface of a grill, or any suitable surface where illumination is desired nearby.

The receiving aperture 13A of the outer casing 12 is sized and shaped to permit the inner casing 14 to be held in the operating position shown in FIGS. 1, 7 and 8, that is extended from within the outer casing 14.

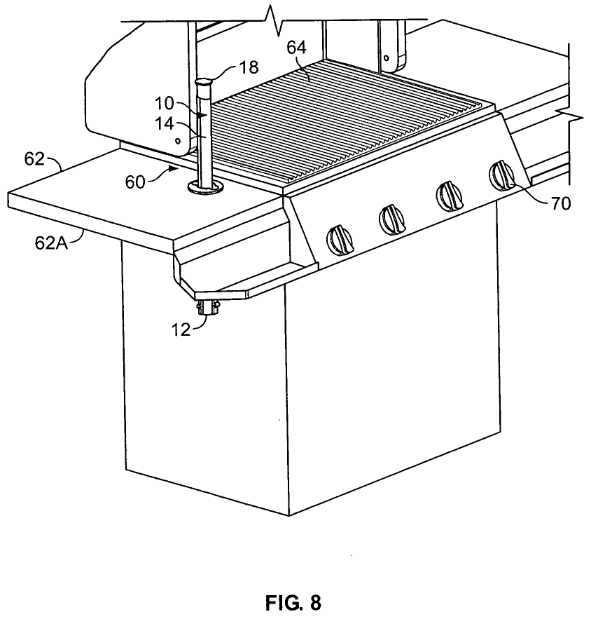

The inner casing 14 includes a light source 46. Embodiments may include one or more LEDs. Preferably, the one or more LEDs are an array of LED elements in a number sufficient to illuminate some or all of an operation area 60 of a grill 62. The operation area 60 includes the working surface 64 (see FIG. 8, for example) but could include a portion of or the entire operation area 60 of the side shelves 62A of grill 62.

Embodiments of the inner casing 14 may include light sources positioned at or adjacent to an upper end 14A of or all or some of the length 14B of the inner casing. A cap 18, preferably transparent or translucent, providing a lens effect may be positioned over the light source 46 and provide some protection thereto.

The light source 46 requires a source of electricity (not shown). It is considered well within the abilities of one with skill in the art to provide electricity to the light source 46. For example, one or more batteries (not show) may be provided in or adjacent to the inner casing with electrical connections to the light source 46. A switch (not shown) may be provided for permitting electrical current to flow to and from the light source and the battery. The electric power may be supplied from a source external to the inner casing 14 or to the assembly 10 such as through known circuitry. In one embodiment, a solar panel may be provided on or near the barbeque for supplying the electricity to the assembly 10 such as for directly powering or charging the battery or batteries for light source 46. Another embodiment includes conversion of the heat energy produced by the grill into electric potential. Any suitable source of electricity is contemplated by the present invention.

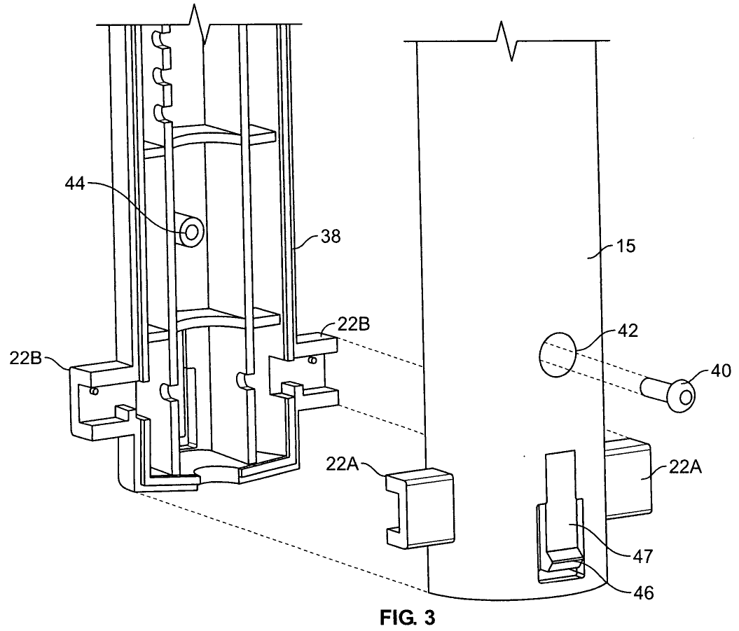

The embodiment of the assembly 10 shown in FIGS. 2 and 3 may include an inner casing 14 having one or more pin 22 positioned so as to extend into the channel 20 of the outer casing 12. Pins 22 serve to maintain alignment of the inner casing 14 relative to the outer casing 12, prohibit removal of the inner casing from the outer casing, and provide limits or stops to the travel of the inner casing with respect to the outer casing. The present invention contemplates any suitable means for maintaining the alignment of the inner casing 14 and outer casing 12 while permitting a sliding relationship therebetween. It is contemplated by the present invention that the means of alignment and sliding engagement of the inner casing 12 and outer casing 14 may include other structures such as grooves, bushings and other elements as is known in the art (not shown).

FIG. 2 illustrates the retractable light 10 in a retracted condition. The retractable light 10 includes an outer casing 12, which is formed of the first outer housing component 31 and a second outer housing component 32. The first outer housing component 31 and a second outer housing component 32 match with each other to form the outer casing 12, which takes the general form of a hollow cylinder. The first outer housing component 31 and a second outer housing component 32 may be joined by inserting screws (not shown) through projections 34. Projections 34 may be self-tapping. It will be understood that the outer casing 12 may be any suitable number of components and joined in any suitable fashion known in the art.

The outer casing 12 of FIG. 2 includes an illustrated one of a pair of channels 20 formed through the outer casing. A pair of channels 20 is preferred, but one or more channels may be used. A pin 22 connected to and extending from the inner casing 14 (see FIG. 1) is positioned in the channel 20. The pin 22 may be rectangular, rounded, square or any suitable shape. The number of pins 22 preferably coincides with the number of channels 20. The outer casing 12 includes a flange 16. An opposed pair of access holes 28 are formed through the flange 16. When in the retracted position the cap 18 may preferably be aligned flush with the flange 16. In an alternate embodiment, the cap 18 is provided inclined relative to horizontal to enhance the shedding of water or other fluids, which may inadvertently land on the lens cap and potentially harm the light source 46 (FIG. 1) underneath. Furthermore, the cap 18 is translucent so that a user can tell whether the light is on or off when in the retracted position.

The user may grasp the cap 18 by inserting fingers into the access holes 28 in the flange 16 and by pulling upwardly will cause the cap 18 and thus, the inner casing 14 (FIG. 1) to be extracted and extend from the outer casing 12 aperture 13A.

FIG. 3 illustrates a partially exploded close-up view of the first inner 15 housing component 36 and second inner housing component 38, which fit together to form the inner casing 14 (see FIG. 1). The first inner housing component 36 and second inner housing component 38 may be held together by any known means, but are preferably held together by a threaded fastener 40 which fits into an opening 42 of the first inner housing component 36 and threads into a boss 44 extending from a corresponding component of the second inner housing component 38. Of course, the inner casing 14 (FIG. 1) may be formed of one or more components.

Each of the pins 22 may be formed of pin halves whereby the first inner housing component 36 includes first pin half 22A which match to second pin half 22B formed on the second housing component 38. The first inner housing component 36 and second inner housing component 38 each may include a pawl 46 on a stiff, but flexible arm 47. In use of the retractable light 10, and again referring also to FIG. 1, each pawl 46 fits into a corresponding notch (not shown) formed on an inside of the outer casing 12 to retain the inner casing 14 in an extended position. The present invention contemplates any known means of retaining the inner casing 14 extended from the outer casing 12.

When the inner casing 14 is urged downwardly, the arm 47 flexes and permits the pawl 46 to move inwardly and disengage from the notch, thus releasing the inner casing 14 from the outer casing 12 and permitting the inner casing to be retracted into the outer casing 12. Preferably, each of first inner housing component 36 and second inner housing component 38 includes a pawl 46 formed on an arm 47 or an equivalent feature.

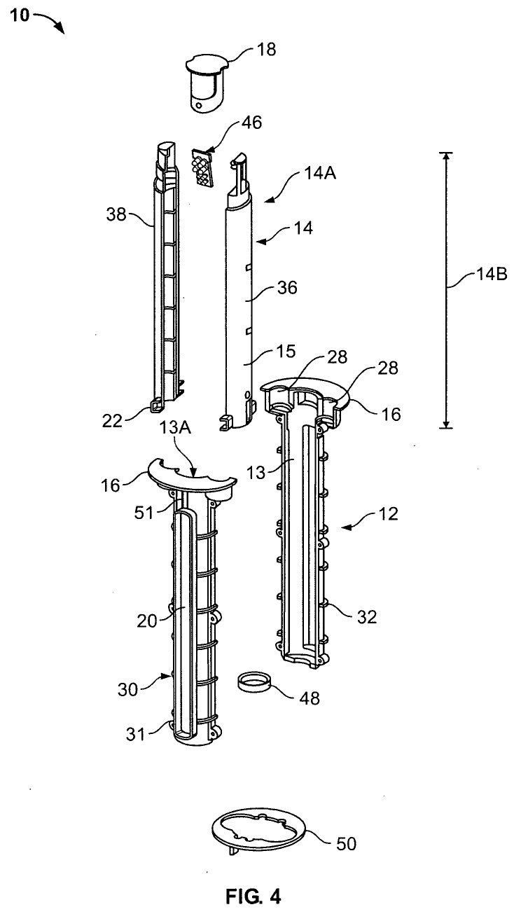

FIG. 4 illustrates a partially exploded view of a retractable light 10 wherein the first outer housing component 31 and second outer housing component 32 fasten together to form the outer casing 12. The first outer housing component 31 and second outer housing component 32 each include a channel 20 formed longitudinally therethrough. The outer casing includes a ring-shaped stop 48 disposed inside the outer casing to stop the inner casing 14 when retracted. The stop 48 may be a rubber ring or the like or any suitable means of preventing the further travel of the inner casing 14.

The inner casing 14 may be formed of a first inner housing component 36 and a matching second inner housing component 38, which, when fastened together, slidingly fits within the aperture 13A of outer casing 12. The inner casing 14 may include a pair of opposed pins 22, which are sized and positioned to slidingly fit within respective channels 20. Opposite the pins 22, a light source 46 is captured between first inner housing component 36 and the second inner housing component 38 of the inner casing 14. Any suitable mount for the light source 46 may be employed. Cap 18 fastens on the inner casing 14 so as to cover light source 46.

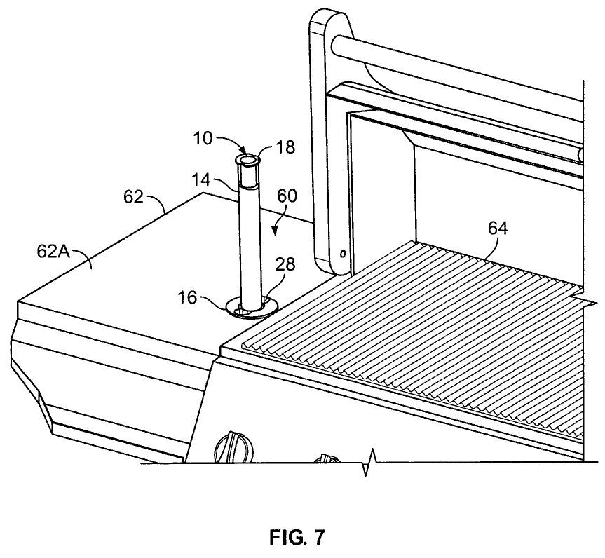

Theft deterrent ring 50 is provided to hold the assembly 10 securely within the surface 62 to which it is attached. The ring 50 provides stability to the light assembly 10 by clamping the flange 16 to the shelf 62 (see FIG. 7). As will be shown in more detail in FIGS. 6-8, after the assembly 10 is positioned in a grill, the retaining ring 50 is placed under the operation area 60 and rotated or slid into position. The ring locks in place by engaging tabs 51 (see also FIG. 1) of the assembly 10 and prevents casual removal of the assembly. The tab(s) 51 and ring 50 locking mechanism may also be snapped into engagement and may permit removal of the assembly by depressing tab 51 and removing the ring.

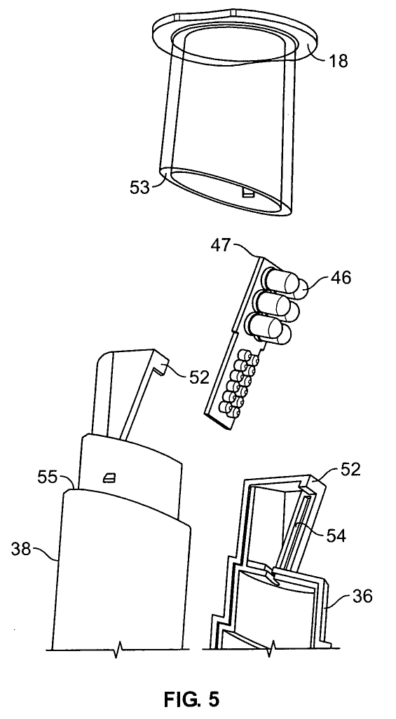

FIG. 5 illustrates one preferred method of mounting the light source 46 to the first inner housing component 36 and the second inner housing component 38. The first inner housing component 36 and the second inner housing component are provided with inclined faces 52. Adjacent the inclined faces 52 are a pair of matching inclined grooves 54. The light source 46, in a preferred embodiment, is an array of LEDs mounted on a flat board, such as a PC board 47. The PC board 47 fits into the matching grooves 54 and thus is held at an inclined angle with respect to vertical. It will be understood that the angle which the PC board 47 and thus the light source 46 is held may be varied according to the intended application, with the object of illuminating an adjacent or nearby operation area 60. The PC board 47 and light source 46 may be fixed between the first inner housing component 36 and the second inner housing component 38. The cap 18 may be positioned over the top thereof. Preferably, the cap 18 covers the entire light source 46 and PC board 47 in order to reduce or prevent moisture from coming into contact therewith. In a preferred embodiment of the invention, a lower angled surface 53 of the cap 18 matches with an angled shoulder 55 on the inner casing 14. The lower angled surface 53 and angled shoulder 55 also functions to direct water or other fluids from entering the inside of the inner casing 14 and contaminating or coming into contact with the electrical wiring, switches or other moisture sensitive elements (not shown).

FIG. 6 illustrates retractable light 10 positioned in an operation area 60 of a grill 62. Preferably, the retractable light 10 may be spaced a distance from the working surface 64, to prevent heat damage to the retractable light 10. For example, the light 10 may be positioned within a recess in the operation area 60 by a distance that is appropriate for the possible heat generated from the working surface 64 and the materials from which the assembly 10 is made.

The assembly 10 is shown in the retracted condition with the cap 18 essentially flush with the flange 16. Access holes 28 may be formed within the flange 16 in cooperation with the cap 18. The cap 18 may be grasped by inserting the user's fingers into the access holes 28 in order to extend the retractable light 10.

FIG. 7 illustrates retractable light 10 positioned into an operation area 60 of a grill 62. In this illustration, the retractable light is shown in an extended condition. The inner casing 14 is shown extending above the operation area 60 of grill 62 and cap 18 in a position relative to working surface 64 sufficient to illuminate the surface 64. It will be understood, that inserting the fingers in access holes 28 of the flange 16, and withdrawing the inner casing 14 by way of the cap 18 in an upward direction accomplishes this.

FIG. 8 illustrates retractable light 10 positioned in an operation area 60 of grill 62. Retractable light 10 includes outer casing 12 within which inner casing 14 is positioned as described above. As shown, inner casing 14 has been extended from outer casing 12 so that cap 18 is exposed and in a position to direct light onto the working surface 64 of grill 62. It will be understood that one or more retractable light 10 may be provided to the grill 62 to particularly illuminate one or more separate areas of the operation area 60 of the grill 62 such as the control features 70 or a tool tray (not shown).

Whilst the above-described assembly is intended, in one embodiment to be used with a barbeque, it is to be realized that the retractable light illustrated and described herein could be incorporated in other apparati with similar or equivalent benefits for illuminating any desired operation area.

Whilst endeavoring in the foregoing specification to draw attention to those features of the invention believed to be of particular importance it should be understood that the Applicants claim protection in respect of any patentable feature or combination of features hereinbefore referred to and/or shown in the drawings whether or not particular emphasis has been placed thereon. While the apparatus and method herein disclosed forms a preferred embodiment of this invention, this invention is not limited to that specific apparatus and method, and changes can be made therein without departing from the scope of this invention, which is defined in the appended claims.

What is claimed is:

1. A retractable light assembly for providing illumination to an operation area, comprising:
an outer casing including a mount attachable to a surface and an inner surface defining a receiving aperture;
an inner casing sized and shaped to be extendably disposed in said receiving aperture; and
a light source operably attached to a power source, said light source being positioned in said inner casing so as to provide the illumination when said inner casing is in an extended condition from said outer casing.

2. The retractable light assembly of claim 1, wherein said outer casing includes a first outer housing component connected to a second outer housing component.

3. The retractable light assembly of claim 2, wherein said outer casing includes one or more longitudinal channels formed through.

4. The retractable light assembly of claim 3, wherein said inner casing includes one or more pins extending therefrom, each of said one or more pins being sized, shaped and positioned so as to slidingly engage with a respective one of said one or more longitudinal channels.

5. The retractable light assembly of claim 1, wherein said mount includes a flange extending from said outer casing to mount said retractable light assembly flush with a surface when said retractable light assembly is in a retracted condition.

6. The retractable light assembly of claim 5, wherein said flange includes a pair of access holes sized and shaped to permit a user to grasp said inner casing.

7. The retractable light assembly of claim 1, further including a cap, said cap being positioned atop said inner casing and covering said light source.

8. The retractable light assembly of claim 7, wherein said cap permits light to be transmitted therethrough and functions as a lens element.

9. The retractable light assembly of claim 7, wherein said inner casing includes an inclined shoulder which is annular and said cap includes an inclined bottom edge to match said inclined shoulder.

10. The retractable light assembly of claim 1, wherein said light source includes an array of LEDs.

11. The retractable light assembly of claim 1, wherein said inner casing includes a pawl and said outer casing includes a notch, said notch being positioned in said outer casing such that said pawl and said notch engage when said inner casing is extended from said outer casing.

12. The retractable light assembly of claim 1, wherein said inner casing telescopes from said outer casing.

13. A lightable barbeque assembly, comprising:
a barbeque including an operation area; and
an outer casing including a mount attachable to a surface and an inner surface defining a receiving aperture;
said mount being attachable to said barbeque;
an inner casing sized and shaped to be extendably disposed in said hollow outer casing; and
a light source is operably attached to a power source, said light source being positioned in said inner casing so as to illuminate said operation area of said barbeque when said inner casing is in an extended condition.

14. The retractable light assembly of claim 13, wherein said outer casing includes a first outer housing component connected to a second outer housing component.

15. The retractable light assembly of claim 14, wherein said outer casing includes one or more longitudinal channels formed through.

16. The retractable light assembly of claim 15, wherein said inner casing includes a one or more pins extending therefrom, each of said one or more pins sized, shaped and positioned so as to slidingly engage with a respective said one or more longitudinal channels.

17. The retractable light assembly of claim 13, wherein said mount includes a flange extending from said outer casing to mount said retractable light assembly flush with a surface of said barbeque when said retractable light assembly is in a retracted condition.

18. The retractable light assembly of claim 17, wherein said flange includes a pair of access holes sized and shaped to permit a user to grasp said inner casing.

19. The retractable light assembly of claim 13, further including a cap, said cap being positioned atop said inner casing and covering said light source.

20. The retractable light assembly of claim 19, wherein said inner casing includes an inclined shoulder which is annular and said cap includes an inclined bottom edge to match said inclined shoulder.

21. The retractable light assembly of claim 13, wherein said light source includes an array of LEDs.

22. The retractable light assembly of claim 23, wherein said inner casing includes a pawl and said outer casing includes a notch, said notch being positioned in said outer casing such that said pawl and said notch engage when said inner casing is extended from said outer casing.
